(19) United States
(12) Patent Application Publication
(10) Pub. No.: US 2010/0277880 A1
(43) Pub. Date: Nov. 4, 2010

(54) ELECTRONIC PACKAGE STRUCTURE

(76) Inventors: Jenq-Gong DUH, Hsinchu City (TW); Chia-Yen Tan, Taoyuan County (TW)

Correspondence Address: Muncy, Geissler, Olds & Lowe, PLLC, 4000 Legato Road, Suite 310, FAIRFAX, VA, 22033, US

(21) Appl. No.: 12/433,541

(22) Filed: Apr. 30, 2009

(51) Int. Cl. H01R 12/00

(52) U.S. Cl. 361/760

(57) ABSTRACT

The present invention discloses an electronic package structure, which comprises an electronic element, a plurality of SMA (Shape Memory Alloy) connection portions, and a plurality of solder connection members. One side of the SMA connection portion is joined to the electronic element, and the solder connection member is arranged over the other side of the SMA connection portion. The SMA connection portions can comply with the strains caused by thermal stresses during the operation of the electronic product and can restore the original shape after the thermal stresses disappear. Therefore, the preset invention can prevent the junctions between the SMA connection portions and the electronic element/the solder connection members from the crack or disconnection caused by thermal stresses.

### FIELD OF THE INVENTION

The present invention relates to an electronic package manufacturing process, particularly to an electronic package manufacturing process using a shape memory alloy.

### BACKGROUND OF THE INVENTION

The objective of electronic package is to connect the chip with the substrate, protect the chip, and enhance the strength and stability of the chip. In addition to external mechanical damage, thermal stress also causes the damage of electronic components. Refer to Fig.1, a diagram schematically showing the thermal stress-induced damage of a conventional electronic product. In the conventional flip chip technology, a chip 1 is bonded to a substrate 2 with a plurality of tin-based solderball 3, and a resin 4 is filled into the gap therebetween, whereby the size of an electronic product can be greatly reduced.

The thermal stress generated by the operation of electronic products will damage the materials having different thermal expansion coefficients. For example, the bonding of the chip 1 and the substrate 2 is likely to be damaged by a long period and repeated turn-on and turn-off, and the junctions between the chip 1/substrate 2 and the tin-based solderball 3 are the positions most likely to be damaged.

In another flip chip technology, under-bump metalization (UBM) layers are formed between the solder pads of the chip or substrate and the tin-based solderballs. After the flip chip structure has been used cycledly or at a high temperature for a long time, at least one brittle inter-metallic compounds (IMC) may form in the junction of the UBM layers and the tin-based solderballs. The waste heat generated by an electronic product will cause the expansion of the chip and substrate, which is likely to induce the materials fatigue in the concentration points of thermal stress. After a long time of use, the bonding between the UBM layers and the solder bumps may disconnect, or the tin-based solderballs may be cracked or delaminated.

Refer to FIGS. 2-4 respectively showing the SEM photographs of the sections of the electronic components respectively experiencing 1000-3000 thermal cycles in a temperature range from −50° C. to +125° C. As shown in FIGS. 2 and 3, at least one crack 5 between the chip 1 and the tin-based solderballs 3 is growing with the increasing thermal cycles and finally separates the chip 1 and the tin-based solderball 3 (as shown in FIG. 4).

Therefore, the Inventor is devoted to overcoming the thermal expansion and contraction from the thermal stress during the operation of electronic products to improve the quality of electronic package and the service life thereof.

### SUMMARY OF THE INVENTION

The primary objective of the present invention is to provide an electronic package structure using a shape memory alloy.

To achieve the abovementioned objective, the present invention proposes an electronic package structure, which comprises an electronic element, a plurality of SMA (Shape Memory Alloy) connection portions, and a plurality of solder connection members, wherein one side of the SMA connection portion is bonded to the electronic element, and the solder connection member is arranged over the other side of the SMA connection portion.

Via the abovementioned technical scheme, the present invention features a higher integrity electronic package, a lower defect rate, and a longer service life.

The SMA connection portions of the present invention can absorb the deformation caused by different thermal expansion coefficients of different elements during thermal cycles and can restore the shape thereof via heating, whereby the integrity of the electronic package and the electronic elements thereinside and is maintained. Therefore, the present invention can reduce the defect rate and prolong the service life of the product.

### BRIEF DESCRIPTION OF THE DRAWINGS

FIG. 1 is a diagram schematically showing the thermal stress-induced damage of a conventional electronic product;

FIG. 2 shows the SEM photograph of the section of an electronic component experiencing 1000 thermal cycles;

FIG. 3 shows the SEM photograph of the section of an electronic component experiencing 2000 thermal cycles;

FIG. 4 shows the SEM photograph of the section of an electronic component experiencing 3000 thermal cycles;

FIG. 5 is a diagram schematically showing a chip of an electronic package structure according to one embodiment of the present invention;

FIG. 6 is a diagram schematically showing a BGA substrate of an electronic package structure according to one embodiment of the present invention;

FIG. 7 is a diagram schematically showing a PCB substrate of an electronic package structure according to one embodiment of the present invention;

FIG. 8 is a diagram schematically showing the martensite phase of SMA used by an electronic package structure according to one embodiment of the present invention;

FIG. 9 is a diagram schematically showing the austenite phase of SMA used by an electronic package structure according to one embodiment of the present invention;

FIG. 10 is a diagram schematically showing the SEM photograph of the section of an electronic package structure experiencing 2000 thermal cycles according to one embodiment of the present invention; and

FIG. 11 is a diagram schematically showing the SEM photograph of the section of an electronic package structure experiencing 3000 thermal cycles according to one embodiment of the present invention.

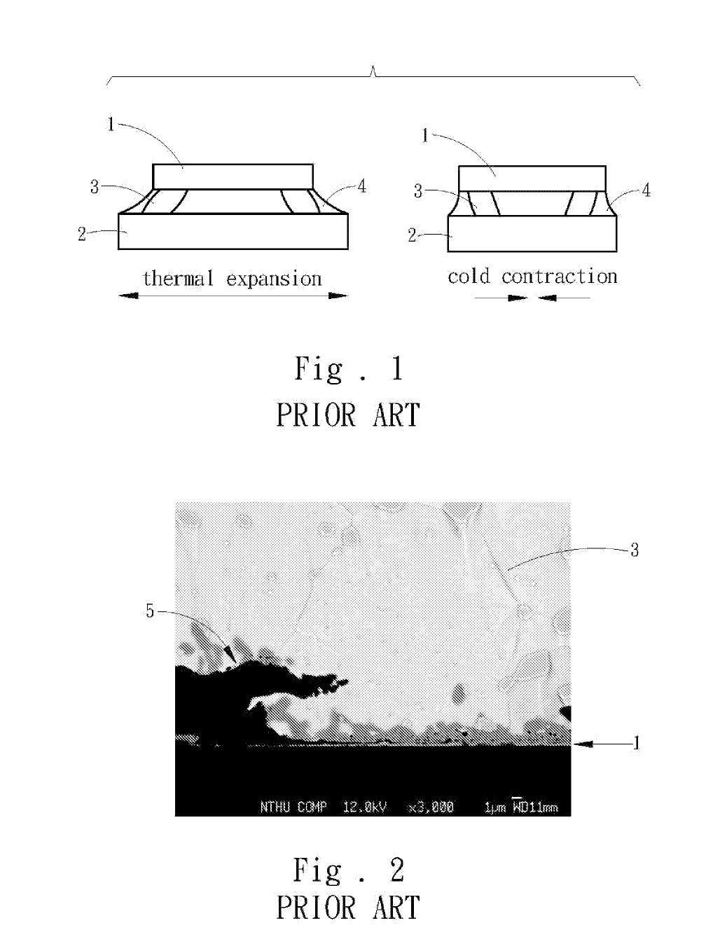

### DETAILED DESCRIPTION OF THE PREFERRED EMBODIMENTS

Below, the technical contents of the present invention are described in detail with the embodiments. However, it should be understood that the embodiments are only to exemplify the present invention but not to limit the scope of the present invention.

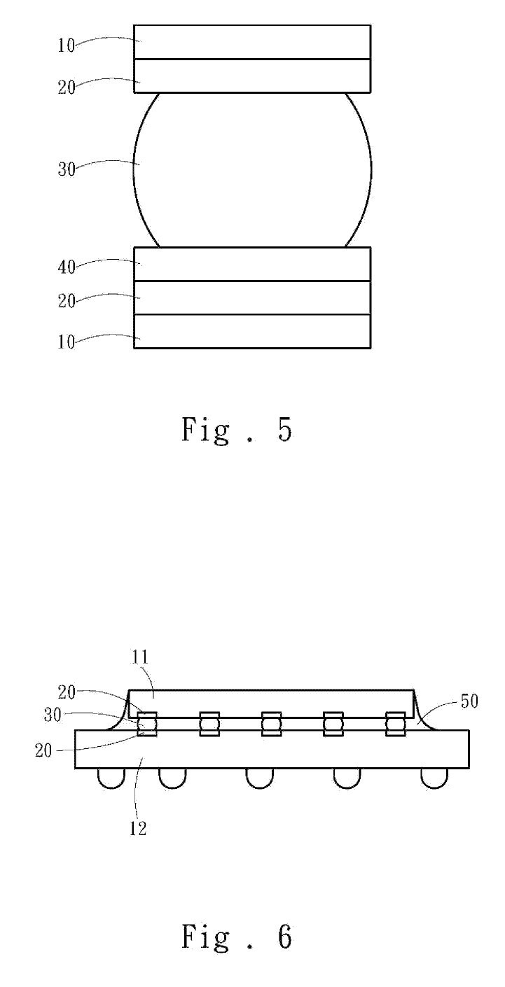

Refer to FIG. 5, a diagram schematically showing an electronic package structure according to one embodiment of the present invention. The present invention proposes an electronic package structure, which comprises an electronic element 10, a plurality of SMA (Shape Memory Alloy) connection portions 20, and a plurality of solder connection members 30. One side of the SMA connection portion 20 is bonded to the electronic element 10, and the solder connection member 30 is arranged over the other side of the SMA connection portion 20. The SMA connection portions 20 may be made of a nickel-titanium SMA, a titanium-iron SMA, nickel-iron SMA, or a titanium-copper SMA. In the embodiment of the present invention, the SMA connection portions 20 are made of a nickel-titanium SMA. The SMA connection portions 20 may be fabricated on the electronic element 10 with an electroplating method, an electroless method, a PVD (Physical Vapor Deposition) method, a CVD (Chemical Vapor Deposition) method, a rolling method, a fusion method, or a powder synthesis method. In the embodiment of the present invention, the SMA connection portions 20 are fabricated on the electronic element 10 with a PVD method, i.e. the vacuum sputter method. In the embodiment of the present invention, the solder connection members 30 are tin-based solderballs.

An adhesion layer 40 may be interposed between the SMA connection portions 20 and the solder connection members 30 to enhance the bonding strength of the solder connection members 30. The adhesion layer 40 may be made of copper, nickel, silver, or tin. The adhesion layer 40 may be fabricated with an electroplating method, an electroless method, or a sputter method. The adhesion layer 40 may be in form of metal bumps.

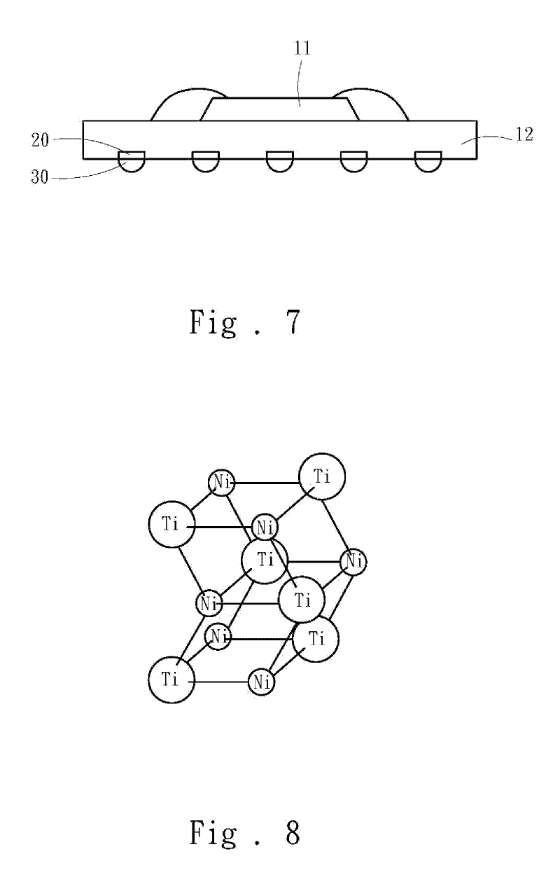

Refer to FIG. 5, FIG. 6 and FIG. 7 diagrams showing the BGA embodiment and the PCB substrate embodiment of the present invention. The electronic element 10 may be a chip 11 having the SMA connection portions 20 in form of solder pads; another electronic element 10 is a circuit substrate 12 having the SMA connection portions 20 in form of solder pads. The circuit substrate 12 may be a PCB (Printed Circuit Board) substrate or a BGA (Ball Grid Array) substrate.

In FIG. 6, the SMA connection portions 20 are arranged both in between the solder connection members 30 and the chip 11 and in between the solder connection members 30 and the circuit substrate 12; the circuit substrate 12 is a BGA substrate, and a resin layer 50 is filled into between the chip 11 and the circuit substrate 12. In FIG. 7, the circuit substrate 12 is a PCB substrate, and the chip 11 is connected to the circuit substrate 12 with a wire-bonding method; the SMA connection portions 20 is arranged in between the solder connection members 30 and the circuit substrate 12.

When external force is applied to a common metallic material, the common metallic material is deformed elastically initially. When the stress reaches the yield point, the common metallic material will be deformed plastically. The permanent deformation of the common metallic material is realized by a dislocation slip mechanism or a twining mechanism and will remain permanently even though the stress has been removed.

The shape memory alloy (SMA) used by the SMA connection portions 20 is a metallic material able to remember the original shape. After the SMA is slightly plastically deformed at a temperature lower than the transformation temperature, heating the SMA can restore the SMA to the original shape before the plastic deformation. Such a phenomenon is called the shape memory effect (SME).

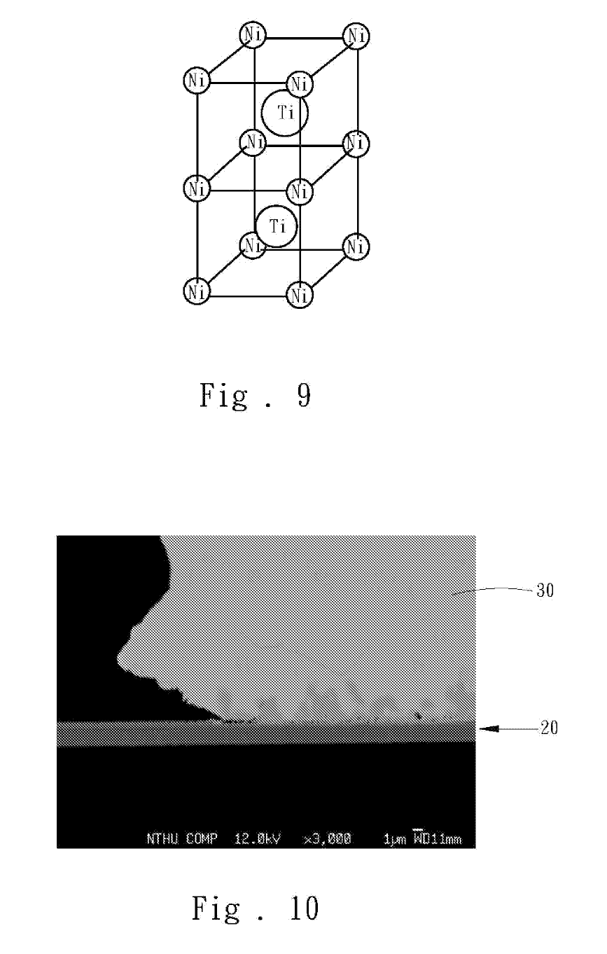

Refer to FIG. 8 and FIG. 9 for the lattice structures of the martensite phase and the austenite phase of the nickel-titanium SMA used by the SMA connection portions 20. Due to the shape memory effect (SME) of the SMA connection portions 20, the greater circles represent the titanium atoms and the smaller circles represent the nickel atoms. FIG. 8 shows the orthorhombic lattice structure of the martensite phase of the SMA connection portions 20 at a lower temperature. The SMA connection portions 20 at the ambient temperature with the Young's modulus thereof 30 GPA. As the distance between the atoms can be varied by external force, and can be deformed. When the SMA connection portions 20 are in the austenite phase (as shown in FIG. 9), the Young's modulus thereof is 80GPA. From the view point of the Young's modulus, the martensite has a higher elasticity. However, FIG. 9 shows the SMA connection portion 20 is heated to a temperature higher than the critical temperature, the SMA connection portion 20 is transformed into the austensite phase. In such a condition, the austensite SMA connection portion 20 has superelasticity, which relates to a strain-induced martensitic transformation. In other words, when the stress exceeds a limit, the martensitic transformation occurs in the austenite phase. In such a case, the SMA connection portion 20 can endure a considerable transformation. After the stress is released, the considerable transformation is restored to the austenite phase having a body-centered cubic lattice structure with the titanium atom arranged inside the cubic lattice and the nickel atoms arranged at the eight corners of the cubic lattice. Thus, the distance between the atoms is restored to the original relative positions the atoms have before the deformation, and the SMA connection portions 20 are thus restored to the original shapes. The abovementioned phenomenon provides a higher elasticity for the SMA connection portions 20.

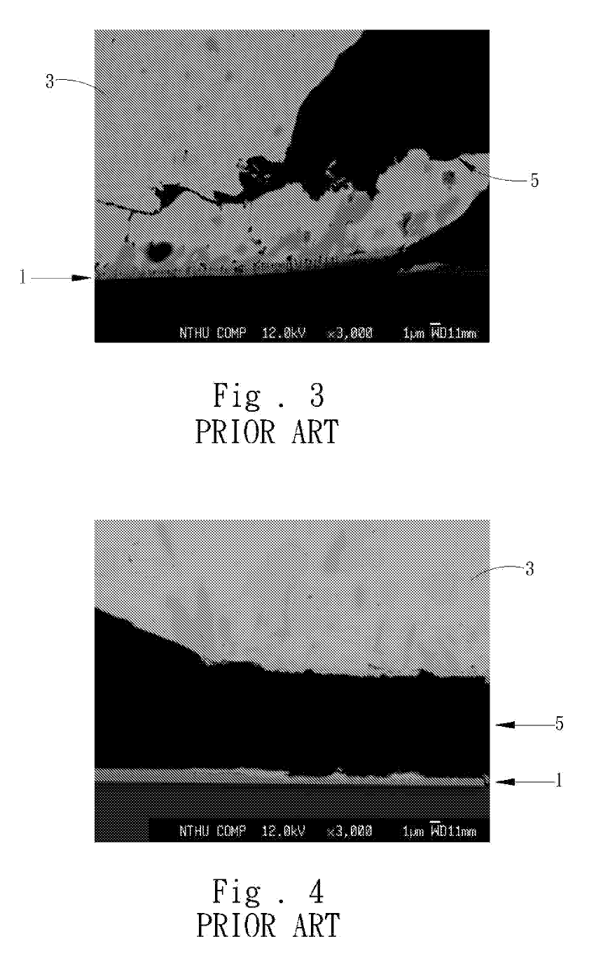

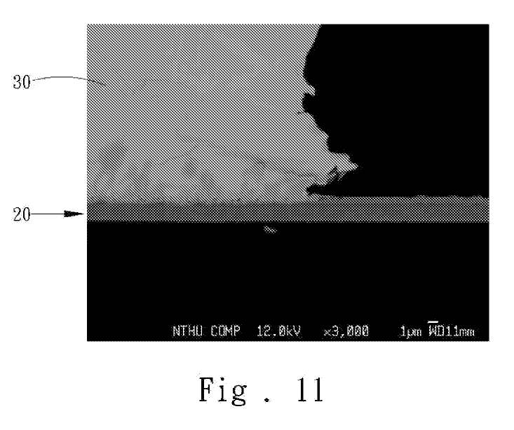

Refer to FIG. 10 and FIG. 11 respectively showing the SEM photographs of the sections of the present invention respectively experiencing 2000 and 3000 thermal cycles in a temperature range of from −50° C. to +125° C. In FIG. 10 and FIG. 11 are not found the crack 5, delamination or disconnection, which appear between the tin-based solderball and the SMA connection portions 20 in the conventional technology (as shown in FIGS. 2-4).

The conventional electronic package manufacturing process is formed of various materials having different thermal expansion coefficients. The strain difference caused by different thermal expansion coefficients during heating is likely to induce cracks 5, delaminations or disconnections and results in the malfunction of the circuit.

The present invention uses the shape memory effect (SME) of the SMA connection portions 20 to overcome the deformation of the electronic package elements, wherein heating the SMA connection portions 20 can restore the SMA connection portions 20 from the deformation to the original shape. Therefore, the present invention can reduce the defect rate and prolong the service life of the product.

What is claimed is:

1. An electronic package structure comprising
an electronic element;
a plurality of SMA (Shape Memory Alloy) connection portions with one side thereof joined to said electronic element; and
a plurality of solder connection members arranged over the other side of said SMA connection portion.

2. The electronic package structure according to claim 1, wherein said SMA connection portions are made of a nickel-titanium SMA, a titanium-iron SMA, a nickel-iron SMA, or a titanium-copper SMA.

3. The electronic package structure according to claim 1, wherein said SMA connection portions are made of a nickel-titanium SMA.

4. The electronic package structure according to claim 1, wherein said SMA connection portions are fabricated on said electronic element with an electroplating method, an electroless method, a PVD (Physical Vapor Deposition) method, a CVD (Chemical Vapor Deposition) method, a rolling method, a fusion method, or a powder synthesis method.

5. The electronic package structure according to claim 1, wherein said SMA connection portions are fabricated on said electronic element with a PVD (Physical Vapor Deposition) method.

6. The electronic package structure according to claim 1, wherein said electronic element is a chip having said SMA connection portions in form of solder pads.

7. The electronic package structure according to claim 1, wherein said electronic element is a circuit substrate having said SMA connection portions in form of solder pads.

8. The electronic package structure according to claim 7, wherein an adhesion layer is interposed between said SMA connection portions on said circuit substrate and said solder connection members.

9. The electronic package structure according to claim 8, wherein said adhesion layer is made of copper, nickel, silver, or tin.

10. The electronic package structure according to claim 8, wherein said adhesion layer is fabricated on said SMA connection portions with an electroplating method, an electroless method, or a sputter method.

11. The electronic package structure according to claim 8, wherein said adhesion layer is in form of metal bumps.

12. The electronic package structure according to claim 7, wherein said circuit substrate is a PCB (Printed Circuit Board) substrate.

13. The electronic package structure according to claim 7, wherein said circuit substrate is a BGA (Ball Grid Array) substrate.

14. The electronic package structure according to claim 1, wherein said solder connection members are tin-based solderball.
